(19) United States
(12) Patent Application Publication
(10) Pub. No.: US 2012/0128918 A1
(43) Pub. Date: May 24, 2012

(54) MOULDING METHOD OF A COMPONENT AND COMPONENT THEREOF

(75) Inventor: Fabio Fiammengo, Mogliano Veneto (IT)

(73) Assignee: Uniteam Italia S.r.l., Quarto d"Altimo, Venezia (IT)

(21) Appl. No.: 13/376,679

(22) PCT Filed: Jun. 12, 2009
(86) PCT No.: PCT/IT09/00259

§ 371 Date: Jan. 30, 2012

(51) Int. Cl. B32B 3/02; B29C 45/14

(52) U.S. Cl. 428/68; 264/255; 264/571

(57) ABSTRACT

Moulding method of a component (8) with a component body (12) and at least one insert (24) able to be at least partially included in the component body (12). The method comprises the phases of making a first injection in a first injection chamber (36) separated from a second injection chamber (40) by means of the insert (24). Subsequently at least one hole is made in the insert (24) to place the second injection chamber (40) in communication with the first moulded portion (16) and a second injection of plastic material is made inside the second injection chamber (40). The material injected traverses at least one hole so as to join the second moulded portion (20) to the first moulded portion (16) and to include the portion of insert (24) lodged in the second injection chamber (40).

### CROSS-REFERENCE TO RELATED APPLICATION

This application is a 371 U.S. National Stage of International Application No. PCT/IT2009/000259, filed Jun. 12, 2009, the disclosure of which is herein incorporated by reference in its entirety.

### FIELD OF THE INVENTION

The present invention relates to the moulding method of a component and relative component made using said moulding method.

### BACKGROUND OF THE INVENTION

It is known of in the art to make moulded components comprising a body and a covering or insert, for example in fabric or leather, joined at least partially to the body.

According to the technique known by the name of ‘back injection’, the insert is fitted onto the die of the mould using hooks positioned outside the injection chamber; so that the surface of the insert is always bigger than the surface of the component body.

The mould is closed therefore blocking the insert at its respective fastenings and the plastic material is injected from the back so as to press the insert against the die of the mould, making the insert adapt to said mould.

The pressure of the injection is such as not to pierce the covering of faux fabric or faux leather which is therefore solidly joined to the component body.

When the moulding cycle is completed, the piece is sent to a (laser or manual) cutting station to eliminate the part of the covering excess to the outline of the component body; lastly the piece is sent to a (manual or automatic) gluing or attachment station to “seal” the free edges of the covering onto the back of the piece, for example by gluing or stapling.

The state of the art technique presents numerous drawbacks and limitations.

First of all, the considerable production waste. Moreover, the known state of the art method foresees various processing phases essentially connected with removal of the strips of covering in excess of the body outline, following extraction of the piece from the mould.

High processing costs due overall to the time, waste, and presence of specific cutting stations of the covering result.

### SUMMARY OF THE INVENTION

The purpose of the present invention is to resolve the drawbacks mentioned with reference to the known technique.

Such drawbacks are resolved by a method according to claim 1 and by a component according to claim 19.

### BRIEF DESCRIPTION OF THE DRAWINGS

Other embodiments of the method and of the component according to the invention are described in the subsequent claims.

Further characteristics and advantages of the present invention will be more easily comprehended from the description below, made by way of a preferred, non-limiting example of embodiment, wherein:

FIGS. 1-5 shows schematic cross-section views of successive moulding phases of a component according to the method of the present invention;

FIG. 6 shows an enlarged view of a part of a mould according to the present invention.

### DETAILED DESCRIPTION OF THE INVENTION

With reference to the aforesaid figures reference numeral 4 globally denotes a mould for injection moulding, specifically for the production of a component 8.

The component 8 comprises a component body 12 having a first portion 16 and a second portion 20, and an insert 24 able to cover at least partially said component body 12.

The mould 4 comprises a die 28 and a punch 32 reciprocally moving according to an axial direction X-X of opening/closing of the mould 4.

The die 28 and the punch 32, in a closed configuration, define a first and a second injection chamber 36, 40 which respectively reproduce in negative the first and the second portion 16, 20 of the component body 12 to be moulded.

The injection chambers 36, 40 are defined by the die 28 and the punch 32, and are beside each other.

According to one embodiment, said insert 24 is a sheet of fabric and/or faux leather able to cover the moulded component 8 at least partially.

Said insert 24 may also be a reinforcement element of the component 8, such as a mesh, a preliminary mould and/or metal sheet.

According to one embodiment, the insert 24 is attached to the inside of the mould 4 by means of a suction device 44 able to create negative pressure between an attachment portion 48 of the insert 24 and the punch 32.

According to a further embodiment, the insert 24 is blocked inside the mould 4 by a moving block 52 which clamps it for example to the punch 32 at an attachment portion 48 of the insert 24.

According to one embodiment, the die 28 of the mould 4 comprises a separation wall 56 between the first and second injection chamber 36, 40; as better described below, the wall 56 influences the insert 24 and co-operates with it to prevent the passage of the injected material between the first and the second injection chamber 36, 40.

The mould 4 comprises, in addition, a moving cursor 60 able to tauten the insert 24 inside the mould 4. The cursor 60 co-operates with the wall 56 and with the insert 24 to insulate the two injection chambers 36, 40 from each other.

According to one embodiment, the cursor 60 is aligned with the wall 56 so that, in an extracted configuration, it forms, with the insert 24 a barrier to the passage of the first injection in the second injection chamber 40.

Preferably, the cursor 60 is fitted with at least one nipper 64 positioned on a work head 68 which comes into contact with the insert 24 in the extracted configuration of the cursor 60, to make at least one hole on the insert 24.

According to one embodiment, the cursor 60 comprises at least one tooth 72 able to grasp the insert 24, so as to facilitate the phase of tautening the insert 24 and of making through holes on the insert 24.

Preferably, the cursor 60 is positioned between the wall 56 and the attachment portion 48 of the insert 24.

In other words, in the closed configuration of the mould 4, the insert 24 is blocked both by the punch 32, at the attachment portion 48, and by the wall 56.

The cursor 60, by means of the work head 68, acts on the portion of insert projecting between the punch 32 and the wall 56, tautening it and making the holes using nippers 64.

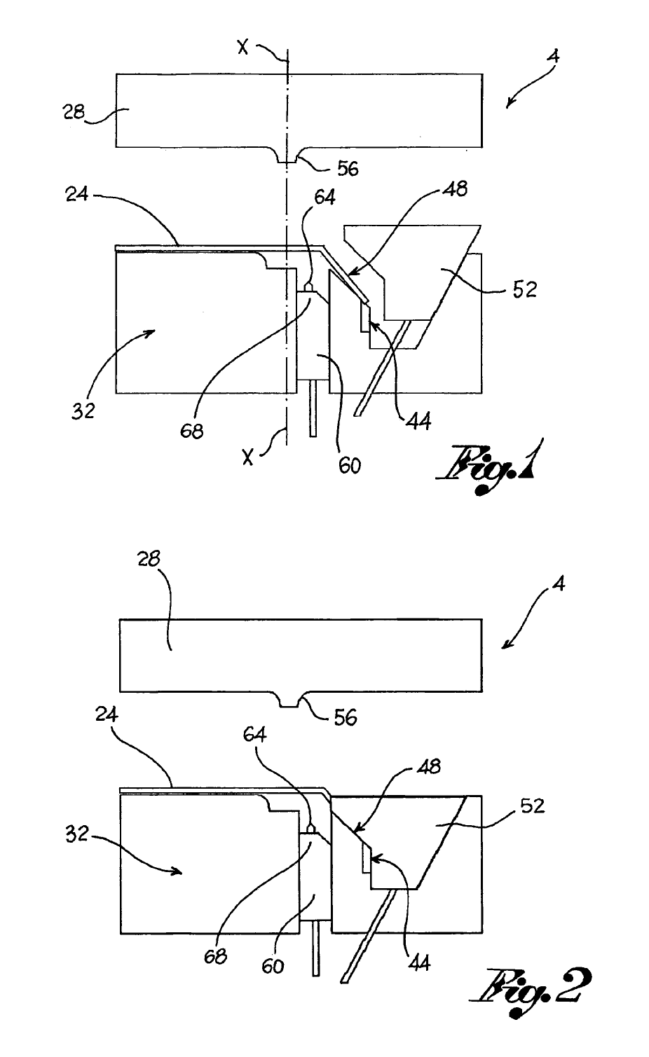

The method of the present invention comprises the phases of positioning the insert 24 inside the first injection chamber 36, for example resting it on the punch 32 at the first injection chamber 36 (FIG. 1).

The insert 24 is then blocked into position by the suction device 44 and/or moving block 52 which is made to hit against the punch 32, pinching it in the middle of the attachment portion 48 of the insert 24 (FIG. 2).

The insert 24 is predisposed so as to separate the first injection chamber 36 from the second injection chamber 40 which reproduces in negative the second portion 20 of the component body 12 to be moulded.

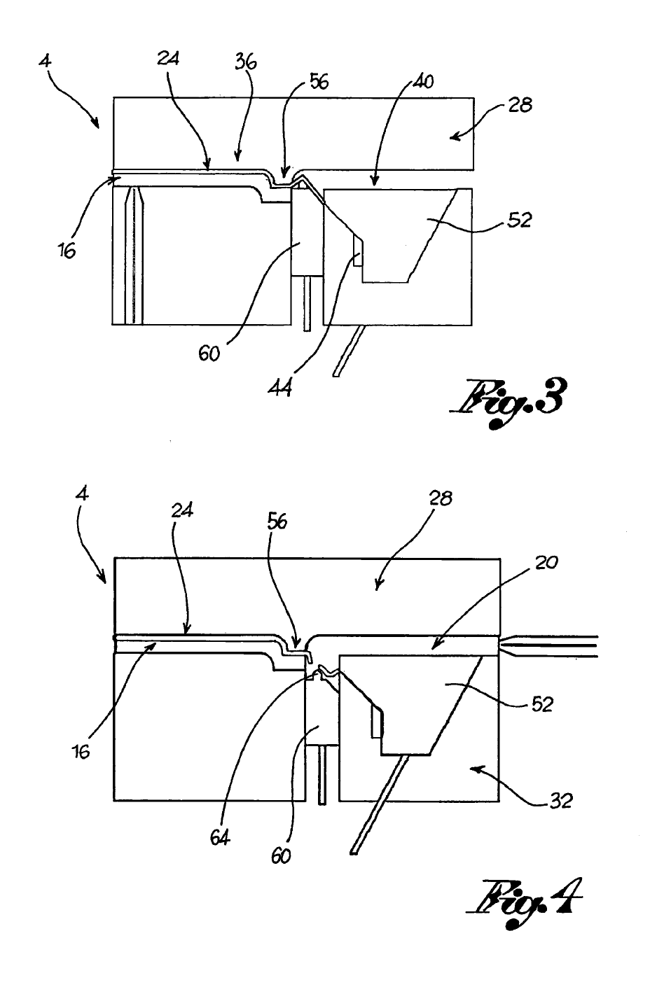

The first injection of plastic material is made inside the first injection chamber 36. Preferably, the first injection is made from the side of the punch 32 so as to fill the first injection chamber 36 and compress the insert 24 against the die 28, joining the insert 24 at the first injection (FIG. 3).

During the first injection, the cursor 60 is in an extracted position so as to tauten the insert 24 pinched between the wall 56 and the block 52.

Preferably, the cursor itself advances so as to form a barrier to the passage of the first injection which remains confined in the first injection chamber 36.

Following the first injection, at least one hole is made in the portion of insert occupying the second injection chamber 40, so as to put the second injection chamber 40 in communication with the first moulded portion 16.

Preferably, the holes in the insert 24 are made by the nippers 64 placed on the work head 68 of the cursor 60 during the extraction of the cursor 60 to tauten the insert 24 (FIG. 3).

The tautening of the insert is in turn facilitated by the teeth 72 placed on the cursor 60 which catch in the insert and pull it with the movement of the cursor 60.

After the solidification of the first injection, the cursor 60 moves rearwards so as to free the holes made by the nippers 64 on the insert, and the second injection of plastic material is made inside the second injection chamber 40. In this phase, the cursor 60 defines the second injection chamber 40, together with the die 28 and the punch 32.

The injected material traverses at least one hole so as to join the second moulded portion 20 to the first moulded portion 16 and to include the portion of insert 24 lodged in the second chamber (FIG. 4).

Specifically, the second injection may cause breakage of the insert 24 at the holes previously made; in any case the torn edges of the insert 24 are included in the second injection.

The second injection is made directly into the second injection chamber 40, for example on the side opposite the wall 56 which defines the first and the second injection chamber 36, 40.

The first and the second injections are made injecting plastic materials compatible with each other, so as to produce adhesion between the first and second portions 16, 20 of the component body 12. In other words, the second injection traverses the holes in the insert and joins with the first portion 16 creating the moulded component in a single piece.

After having made the second injection, the mould is opened and the component 4 expelled in a single piece, comprising the first portion 16, the insert 24 and the second portion 20.

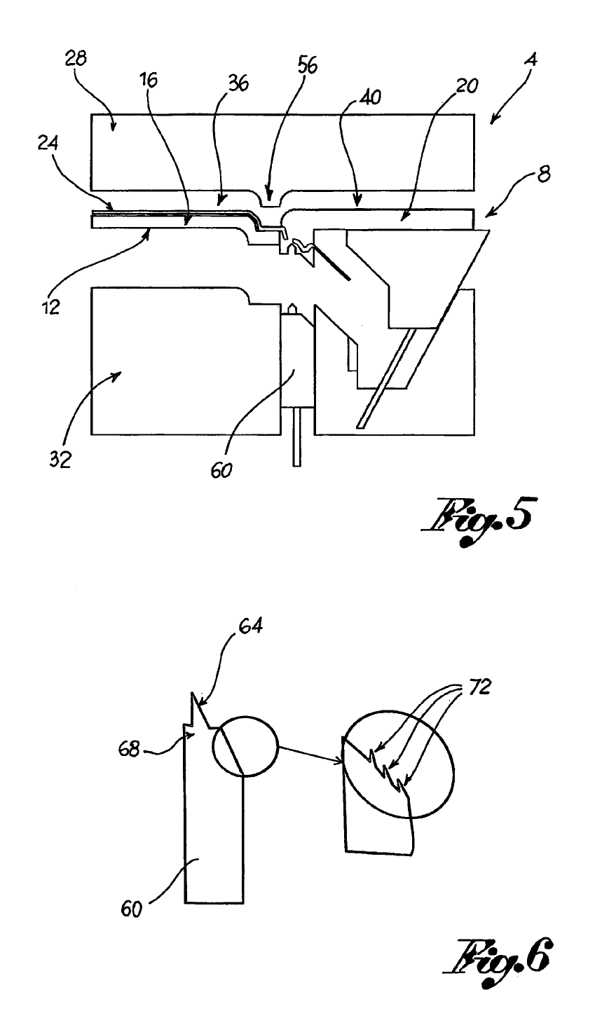

For example, the expulsion phase of the component 8 from the mould 4 may be facilitated by the block 52 (FIG. 5).

As may be seen from the description, the method of the present invention makes it possible to overcome the drawbacks presented in the known technique.

Advantageously, the piece moulded according to the present invention, once extracted from the mould requires no further processing and is ready for assembly.

In fact the edges of insert comprised between the first and the second portion are directly included in the second injection; any edges not included are in any case located on the inner side of the component, that is on the side opposite the insert and therefore not on view, thereby requiring no subsequent removal operations. All the manual or automatic cutting phases subsequent to extraction of the piece from the mould are thus eliminated.

As a result, the piece extracted from the mould is already ready for assembly in that it requires no further processing in terms of cutting or attachment to any other part.

This way production costs and times of moulded pieces comprising coverings are considerably reduced.

The spheres of application of the present invention are varied. For example, bodywork parts of vehicles may be made, such as door panel parts or car mouldings.

In addition, it is also possible to make parts such as airbag pieces, where the mesh holding the cover which explodes after the airbag opens, is used as the insert.

It is also possible to make parts such as engine sheaths, where a preliminary mould or metal sheet is used as the insert.

A person skilled in the art may make numerous modifications and variations to the methods described above so as to satisfy contingent and specific aims while remaining within the sphere of protection as defined by the following claims.

1. A moulding method of a component composed of a component body and at least one insert suitable for including at least partially in the component body, the method comprising:
predisposing a mould comprising at least one die and one punch which, in a closed configuration, define a first injection chamber which respectively reproduces in negative a first portion of the component body to be moulded;
positioning an insert inside the first injection chamber;
predisposing the insert so as to use it to separate the first injection chamber from a second injection chamber reproducing in negative a second portion of the component body to be moulded, the second injection chamber being defined by the die and by the punch and being beside the first injection chamber;
making a first injection of plastic material inside the first injection chamber;
making at least one hole in said insert so as to put the second injection chamber into communication with the first moulded portion; and
making a second injection of plastic material inside the second injection chamber, the injected material traversing at least one hole so as to join the second moulded portion to the first moulded portion and to include the insert portion lodged in the second injection chamber.

2. . The method according to claim 1, wherein said insert is a sheet of fabric and/or faux leather able to cover the moulded component at least partially.

3. The method according to claim 1, wherein said insert is a reinforcement element of the component, such as a mesh, preliminary moulding and/or metal sheet.

4. The method according to claim 1, wherein said insert is attached inside the mould by at least one suction device able to create negative pressure between an attachment portion of the insert and the punch.

5. The method according to claim 1, wherein the insert is attached by a moving block which clamps it to the punch at an attachment portion.

6. The method according to claim 1, wherein the die comprises a separation wall between the first and the second injection chamber, said wall influencing the insert and co-operating with it to prevent the passage of injected material from the first to the second chamber.

7. The method according to claim 1, wherein the mould comprises a moving cursor able to tauten the insert inside the mould.

8. The method according to claim 7, wherein the cursor co-operates with the wall and the insert to insulate the two injection chambers between them.

9. The method according to claim 7, wherein the cursor is aligned with the wall so that, in the extracted configuration, it forms, together with the insert a barrier to the passage of the first injection in the second injection chamber.

10. The method according to claim 7, wherein said cursor is fitted with at least one nipper on a work head, so that in the extracted configuration it makes at least one hole in the insert.

11. The method according to claim 7, wherein the cursor comprises at least one tooth able to catch the insert, so as to facilitate the phase of tautening the insert and making the through holes on the insert.

12. The method according to claim 7, wherein the cursor is positioned between the wall and an attachment portion of the insert to the mould.

13. The method according to claim 7, wherein, between the first and second injection, the cursor is positioned in a retracted configuration, so as to at least partially free the second injection chamber and leave the holes open for the passage of the material injected during the second injection.

14. The method according to claim 1, wherein the first injection is made from the side of the punch so as to fill the first injection chamber and to compress the insert against the die, joining the insert to the first portion of the component body.

15. The method according to claim 7, wherein the second injection is made directly into the second injection chamber, from the side opposite said wall defining the first and the second injection chamber.

16. The method according to claim 1, wherein following the second injection, the mould is opened and the component made in a single piece, comprising the first portion, the insert and the second portion, is expelled from the mould.

17. The method according to claim 1, wherein the expulsion phase of the component from the mould is performed by a block which acts as a blocking element of the insert in the mould.

18. The method according to claim 1, wherein the first and the second injection are made by injecting plastic materials compatible with each other, so as to produce adhesion between the first and second portions of the component body.

19. The moulded component made using a moulding method according to claim 1.
